(19) United States
(12) Patent Application Publication
(10) Pub. No.: US 2016/0139727 A1
(43) Pub. Date: May 19, 2016

(54) TOUCH SCREEN PANEL

(71) Applicant: Samsung Display Co., Ltd., Yongin-City (KR)

(72) Inventors: Jung-Hyun KIM, Yongin-City (KR); Sung-Ki JUNG, Yongin-City (KR)

(21) Appl. No.: 14/820,388

(22) Filed: Aug. 6, 2015

(30) Foreign Application Priority Data
Nov. 13, 2014 (KR) 10-2014-0158255

(51) Int. Cl. G06F 3/041; G06F 3/047; G06F 3/044

(52) U.S. Cl. CPC G06F 3/0416; G06F 3/044; G06F 3/047; G06F 2203/04103; G06F 2203/04104; G06F 2203/04111

(57) ABSTRACT

Disclosed is a touch screen panel, including: a first substrate including an active area and a non-active area outside the active area; a first detection electrode and a second detection electrode electrically connected to one identical electrode wire within the active area of the first substrate; and a first common electrode overlapping the first detection electrode and a second common electrode overlapping the second detection electrode.

### CROSS-REFERENCE TO RELATED APPLICATION

This application claims priority to and the benefit of Korean Patent Application No. 10-2014-0158255, filed on Nov. 13, 2014, in the Korean Intellectual Property Office, the entire contents of which are incorporated herein by reference in their entirety.

### BACKGROUND

1. Field

The present inventive concept relates to a touch screen panel.

2. Description of the Related Art

A touch screen panel is an input device for enabling a user to input a command by touching instruction displayed on a screen of an image display device and the like by using a hand of a person or a tool like stylus pen. The touch screen panel may replace a separate input device, such as a keyboard and a mouse, which is connected to an image display device, so that a use of the touch screen panel has been gradually expanded.

The touch screen panel may be implemented as a resistive type, a light detection type, and a capacitive type. Among them, the capacitive type includes a self-capacitance type and a mutual capacitance type. The self-capacitance type has an advantage in that it is easy to implement hovering and a multi-touch technology. In a self-capacitive touch screen panel, a plurality of separated conductive detection electrodes is formed on one surface of a substrate, and each of the plurality of detection electrodes corresponds to unique location information. Further, the self-capacitive touch screen panel detects a variation in capacitance of the detection electrode when a hand of a person or a stylus pen is in contact with the touch screen panel to calculate a touch position.

The self-capacitive touch screen panel in the related art includes a plurality of electrode wires one-to-one connected to the plurality of detection electrodes, and the plurality of electrode wires is arranged between the detection electrodes. An area, in which the electrode wires are positioned, may act as a dead zone, in which the touch detection is not possible or a touch signal is distorted, even though the area is within an active area in which a touch is made. When the number of detection electrodes is increased, the number of electrode wires is increase in proportion to the number of detection electrodes, so that there is a problem in that touch performance is degraded by the dead zone within the active area.

### SUMMARY

An exemplary embodiment of the present inventive concept provides a touch screen panel, including: a first substrate including an active area and a non-active area outside the active area; a first detection electrode and a second detection electrode electrically connected to one identical electrode wire within the active area of the first substrate; and a first common electrode overlapping the first detection electrode and a second common electrode overlapping the second detection electrode.

The touch screen panel may further include a touch controller configured to calculate touch coordinates based on a first signal from the first and second detection electrodes and a second signal from the first and second common electrodes.

The first common electrode and the second common electrode may extend along a first direction and are alternately disposed.

The first common electrodes may have a plurality of first portions extending along a first direction and a second portion connecting the plurality of first portions, the second portion extending along one edge of the first substrate to be connected to a pad unit, and the second common electrodes may have a plurality of first portions extending along the first direction and a second portion connecting the plurality of first portions, the second portions extending along the other edge of the first substrate to be connected to the pad unit.

The first common electrode and the second common electrode may be connected to different potentials. The first common electrode and the second common electrode may be connected to the same potential. The first common electrode and the second common electrode may be connected to a ground potential.

The first and second detection electrodes may be disposed on one surface of the first substrate, and the first and second common electrodes may be disposed on the other surface opposite to the one surface of the first substrate. The touch screen panel may further include a pad unit disposed in the non-active area on the one surface of the substrate, in which the first and second common electrodes are electrically connected to the pad unit through vertical connection parts passing through the first substrate, respectively.

The first and second detection electrodes may be alternately disposed. The electrode wire may pass through the active area and be connected to the pad unit in the non-active area. The first and second detection electrodes may have a matrix pattern. The touch screen panel may further include an insulation layer disposed between a layer, on which the first and second detection electrodes are disposed, and a layer, on which the first and second common electrodes are disposed. The touch screen panel may further include a third detection electrode electrically connected to the electrode wire, in which the first common electrode and the second common electrode do not overlap the third detection electrode.

The first common electrode and the second common electrode may extend along a first direction and be alternately disposed.

The first common electrodes may have a plurality of first portions extending along a first direction and a second portion connecting the plurality of first portions, the second portion extending along one edge of the first substrate to be connected to a pad unit, and the second common electrodes may have a plurality of first portions extending along the first direction and a second portion connecting the plurality of first portions, the second portions extending along the other edge of the first substrate to be connected to the pad unit.

The first and second detection electrodes may be disposed on one surface of the first substrate, and the first and second common electrodes may be disposed on the other surface opposite to the one surface of the first substrate.

The touch screen panel may further includes an insulation layer disposed between the first and second detection electrodes and the first and second common electrodes. The insulation layer, the first and second detection electrodes and the first and second common electrodes may be disposed on one surface of the first substrate.

The touch screen panel may further includes a second substrate on which the first and second detection electrodes are disposed, and an adhesive layer bonding the first substrate and the second substrate. The first and second common electrodes may be disposed on the first substrate.

### BRIEF DESCRIPTION OF THE DRAWINGS

Example embodiments will now be described more fully hereinafter with reference to the accompanying drawings; however, they may be embodied in different forms and the inventive concept should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout the specification.

FIG. 1 is a top plan view schematically illustrating a touch screen panel according to an exemplary embodiment of the present inventive concept.

FIGS. 2A, 2B, and 2C are cross-sectional views of the touch screen panel according to the exemplary embodiments of the present inventive concept.

FIG. 3 is a top plan view of a touch screen panel according to another exemplary embodiment of the present inventive concept.

### DETAILED DESCRIPTION

Hereinafter, an exemplary embodiment of the present inventive concept will be described in detail with reference to the accompanying drawings.

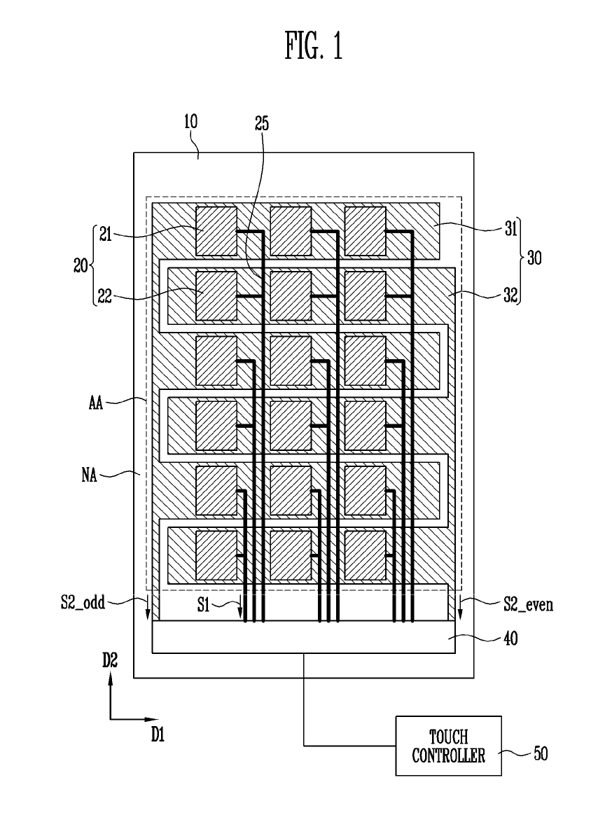

FIG. 1 is a top plan view schematically illustrating a touch screen panel according to an exemplary embodiment of the present inventive concept.

Referring to FIG. 1, a touch screen panel may include a substrate 10, a detection electrode 20, a common electrode 30, a pad unit 40, and a touch controller 50.

The first substrate 10 may be formed of a material having high thermal resistance and chemical resistance, and may have a flexible property in some exemplary embodiments. For example, the first substrate 10 may be a thin film substrate formed of one or more selected from the group consisting of polyethylene terephthalate (PET), polycarbonate (PC), acryl, polymethyl methacrylate (PMMA), triacetyl cellulose (TAC), polyether sulfone (PES), and polyimide (PI). In addition, generally used glass or tampered glass may be utilized as the substrate 10. Further, the substrate 10 may be an encapsulation substrate or an optical member, for example, a polarization film, of an organic light emitting display device or a LCD device.

The substrate 10 may include an active area AA, into which a touch signal may be input, and a non-active area NA positioned outside the active area AA. For a display panel in which a touch screen is integrated, the active area AA which overlaps an image display area of a display panel (not illustrated) is viewed from the outside, and the non-active area NA is not viewed from the outside because a frame, which overlaps the non-display area and covers the non-display area, or a light blocking layer for blocking light covers the non-active area NA.

The detection electrodes 20 are a plurality of conductive patterns for detecting a touch input, and may be evenly distributed and disposed in the active area AA of the substrate 10. In the touch screen panel of the present inventive concept, two or more detection electrodes 20 are connected to one identical electrode wire 25, and the electrode wire 25 passes through the active area AA and extends to the pad unit 40 of the non-active area NA.

In the present exemplary embodiment, the detection electrode 20 includes a first detection electrode 21 and a second detection electrode 22 electrically connected to the one identical electrode wire 25. The detection electrodes 20 may be arranged in rows and columns to have a lattice structure. The detection electrodes 20 included in odd numbered rows which are arranged along a first direction D1 are classified into the first detection electrodes 21, and the detection electrodes 20 included in even numbered rows are classified into the second detection electrodes 22. That is, the first and second detection electrodes 21 and 22 are alternately disposed along the second direction D2. Adjacent first detection electrode 21 and second detection electrodes 22 are connected to one electrode wire 25.

In the present exemplary embodiment, it is illustrated that the detection electrodes 20 has a quadrangle pattern, but the present inventive concept is not limited thereto, and the detection electrode 20 may have various shapes, such as a polygonal shape including a diamond, a triangle, and a hexagon, a circle, and an ellipse. The detection electrode 20 may be formed of a transparent conductive material, such as an indium-tin-oxide (ITO), an antimony tin oxide (ATO), an indium-zinc-oxide (IZO), a carbon nano-tube (CNT), and graphene. In another exemplary embodiment, the detection electrode 20 may also be formed of a metal having a matrix pattern.

The electrode wire 25 may be formed of the same material on the same layer as that of the detection electrode 20, but may be formed of the different material on the different layer from that of the detection electrode 20. Particularly, the electrode wire 25 may be formed of a transparent conductive material, such as an ITO, an ATO, an IZO, a CNT and graphene, or one or more materials selected from the group consisting of low resistance metal materials, for example, molybdenum (Mo), silver (Ag), titanium (Ti), copper (Cu), and aluminum (Al). The electrode wire 25 is positioned in the active area AA and does not contribute for touch detection, so that the electrode wire 25 may be formed to have the smallest line width at a level of several to several tens of micro meters.

The common electrode 30 is a conductive pattern overlapping the detection electrode 20 in order to improve touch sensitivity and remove noise. The touch screen panel of the present inventive concept includes two or more electrically disconnected common electrode 30. The common electrodes are used as address electrodes for determining a position of a touch input with the aforementioned detection electrodes 20. Two or more common electrodes 30 may be connected to different potentials, or the same potential, for example, ground potential.

In the present exemplary embodiment, the common electrode 30 includes a first common electrode 31 overlapping the odd numbered rows of the detection electrode 20 and a second common electrode 32 overlapping the even numbered rows of detection electrode 20. The first common electrode 31 and the second common electrode 32 are insulated from each other and do not overlap each other. The first common electrode 31 has a plurality of first portions overlapping the detection electrode in the odd numbered rows and a second portion connecting the first portions.

The second portion of the first common electrode 31 extends along one edge of the substrate 10 to be connected to the pad unit 40. The second portion of the first common electrode 31 may be a vertical connection part connecting the plurality of first portions along a vertical direction.

The second common electrode 32 has a plurality of first portions overlapping the detection electrode in the even numbered rows and a second portion connecting the first portions. The second portion of the second common electrode 31 extends along the other edge, which is opposite to one side of the substrate 10, of the substrate 10 to be connected to the pad unit 40. The second portion of the second common electrode 31 may be a vertical connection part connecting the plurality of first portions along a vertical direction

A shape and a wire layout of the common electrode 30 may be variously changed, and the present inventive concept is not limited by the shape and the wire layout of the common electrode 30.

The touch controller 50 is connected to the pad unit 40, and calculates touch coordinates based on a first signal (S1) from the detection electrode 20 and a second signal (S2_odd and S2_even) from the common electrode 30. One pair of detection electrodes connected to the same electrode wire 25 corresponds to unique location information, and the first common electrode 31 and the second common electrode 32 correspond to any one of the first and second detection electrodes 21 and 22. Particularly, the touch controller 50 may determine a touch position, at which a touch input is made, within the active area AA based on the first signal (S1), and determine whether the touch position corresponds to the first common electrode 31 or the second common electrode 32 based on the second signal (S2_odd and S2_even) to accurately calculate touch coordinates. For example, when a touch signal S1 is detected in the electrode wire 25 connected to the first detection electrode 21 and the second detection electrode 22, the touch controller 50 may determine the exact point of touch using the second signal S2_odd and S2_even. For example, when the second signal (S2_odd) of the first common electrode 31 is detected, the touch controller 50 may determine that the touch input is made in the first detection electrode 21. On the contrary, when the second signal (S2_even) of the second common electrode 32 is detected, the touch controller 50 may determine that the touch input is made in the second detection electrode 22.

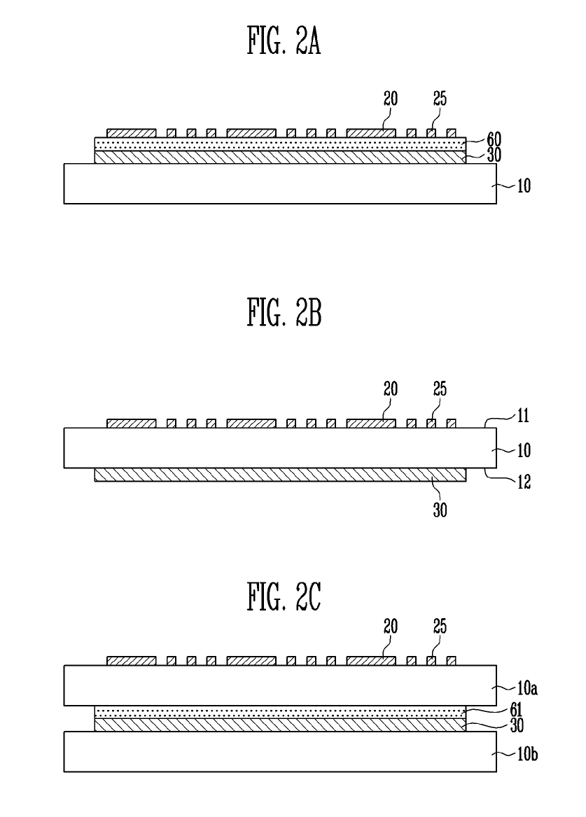

FIGS. 2A, 2B, and 2C are cross-sectional views of the touch screen panel according to the exemplary embodiments of the present inventive concept.

First, referring to FIG. 2A, the touch screen panel according to the present exemplary embodiment includes an insulation layer 60 disposed between the detection electrodes 20 and the common electrodes 30. The common electrodes 30, the insulation layer 60 and the detection electrodes 20 are sequentially formed on a substrate 10. The electrode wires 25 may be formed on the same layer and formed of the same material as the detection electrodes 20. An insulating property may be secured between the detection electrodes 20 and the common electrodes 30 by the insulation layer 60.

Referring to FIG. 2B, the touch screen panel according to the exemplary embodiment has a structure in which the detection electrodes 20 are disposed on a first surface 11 of the substrate 10 and the common electrodes 30 are disposed on a second surface 11 opposite to the first surface 11. Here, although not illustrated in detail, the pad unit 40 is disposed in a non-active area NA of the first surface 11 of the substrate 10, and the common electrodes 30 disposed on the second surface 12 may be electrically connected to a pad unit 40 through second portion (not illustrated) passing through the substrate 10, respectively.

Referring to FIG. 2C, the touch screen panel according to the present exemplary embodiment has a structure in which the detection electrodes 20 are disposed on a first substrate 10a, and the common electrodes 30 are disposed on a second substrate 10b. Further, an adhesive layer 61 may be interposed between the first substrate 10a and the second substrate 10b. The adhesive layer 61 is a means for bonding the first substrate 10a and the second substrate 10b, and an optically clear adhesive (OCA) film may be used as the adhesive layer 61, but the adhesive layer 61 is not limited thereto. The touch screen panel according to the present exemplary embodiment may be manufactured by forming the detection electrodes 20 and the common electrodes 30 on the two substrates 10a and 10b, respectively, and bonding the two substrates 10a and 10b by using the adhesive layer 61.

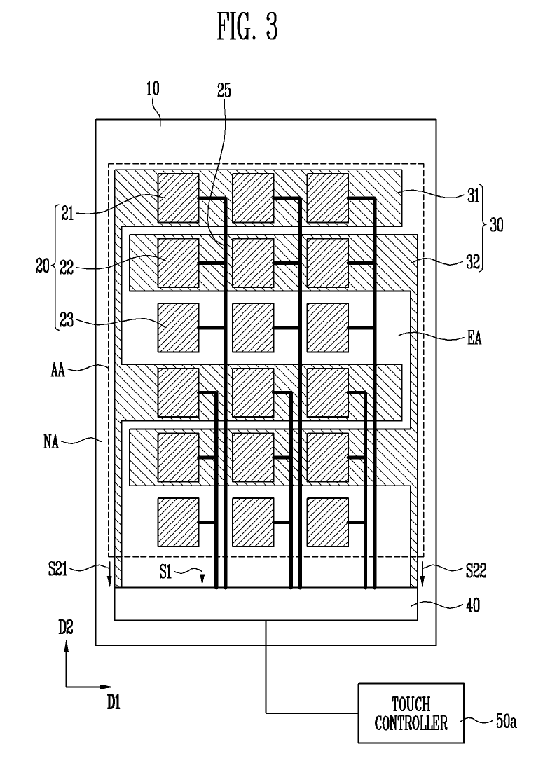

FIG. 3 is a top plan view of a touch screen panel according to another exemplary embodiment of the present inventive concept.

Constituent elements having the same reference numerals as those of the aforementioned constituent elements will be referred to the aforementioned disclosed contents unless being contradicted, and overlapping descriptions will be omitted.

Referring to FIG. 3, the touch screen panel according to the present exemplary embodiment has a structure in which a third detection electrode 23 is connected to one identical electrode wire 25 together with a first detection electrode 21 and a second electrode 22, and the common electrode 30 includes an empty area EA which does not overlap the third detection electrode 23. Particularly, in the detection electrode 20, a first detection electrode 21 is arranged in the first row, a second detection electrode 22 is arranged in the second row, and a third detection electrode 23 is arranged in the third row, and the three detection electrodes 21, 22, and 23, which are one unit, are connected to the same electrode wire 25. In the common electrode 30, a first common electrode 31 overlapping the first detection electrode 21 is disposed in the first row, and a second common electrode 32 overlapping the second detection electrode 22 is disposed in the second row, and no conductive pattern overlapping the third detection electrode 23 is formed in the third row.

A touch controller 50a according to the present exemplary embodiment may determine a touch position, at which a touch input is generated, within an active area AA based on a first signal (S1), and determine whether the touch position corresponds to the first common electrode 31, the second common electrode 32, or the third detection electrode 23 based on a second signal (S21 and S22) to accurately calculate touch coordinates. For example, when a touch signal S1 is detected in the electrode wire 25 connected to the first detection electrode 21, the second detection electrode 22 and the third connection electrode 23, the touch controller 50a may determine the exact point of touch using the second signal S21 and S22. For example, when the second signal (S21) of the first common electrode 31 is detected, the touch controller 50a may determine that the touch input is made in the first detection electrode 21. When the second signal (S22) of the second common electrode 32 is detected, the touch controller 50a may determine that the touch input is made in the second detection electrode 22. When the second signals (S21 and S22) are not detected, the touch controller 50a may determine that the touch input is made in the third detection electrode 23.

According to the present inventive concept, the plurality of detection electrodes 20 is connected to one identical electrode wire 35 and the plurality of common electrodes 30 overlapping the detection electrodes 20, respectively, is provided, so that it is possible to improve touch performance by reducing a dead zone within the active area AA and decrease a size of the pad unit 40 connected with the plurality of electrode wires 25 by decreasing the number of electrode wires 25.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present inventive concept as set forth in the following claims.

What is claimed is:

1. A touch screen panel, comprising:
a first substrate including an active area and a non-active area outside the active area;
a first detection electrode and a second detection electrode electrically connected to one identical electrode wire within the active area of the first substrate; and
a first common electrode overlapping the first detection electrode and a second common electrode overlapping the second detection electrode.

2. The touch screen panel of claim 1, further comprising:
a touch controller configured to calculate touch coordinates based on a first signal from the first and second detection electrodes and a second signal from the first and second common electrodes.

3. The touch screen panel of claim 1, wherein the first common electrode and the second common electrode are insulated from each other and do not overlap each other.

4. The touch screen panel of claim 3, wherein the first common electrode and the second common electrode extend along a first direction and are alternately disposed.

5. The touch screen panel of claim 1, wherein the first common electrodes have a plurality of first portions extending along a first direction and a second portion connecting the plurality of first portions, the second portion extending along one edge of the first substrate to be connected to a pad unit, and
the second common electrodes have a plurality of first portions extending along the first direction and a second portion connecting the plurality of first portions, the second portions extending along the other edge of the first substrate to be connected to the pad unit.

6. The touch screen panel of claim 1, wherein the first common electrode and the second common electrode are connected to different potentials.

7. The touch screen panel of claim 1, wherein the first common electrode and the second common electrode are connected to the same potential.

8. The touch screen panel of claim 7, wherein the first common electrode and the second common electrode are connected to a ground potential.

9. The touch screen panel of claim 1, wherein the first and second detection electrodes are disposed on one surface of the first substrate, and
the first and second common electrodes are disposed on the other surface opposite to the one surface of the first substrate.

10. The touch screen panel of claim 9, further comprising:
a pad unit disposed in the non-active area on the one surface of the first substrate,
wherein the first and second common electrodes are electrically connected to the pad unit through vertical connection parts passing through the first substrate, respectively.

11. The touch screen panel of claim 1, wherein the first and second detection electrodes are alternately disposed.

12. The touch screen panel of claim 1, wherein the electrode wire passes through the active area and is connected to the pad unit in the non-active area.

13. The touch screen panel of claim 1, wherein the first and second detection electrodes have a matrix pattern.

14. The touch screen panel of claim 1, further comprising:
an insulation layer disposed between a layer, on which the first and second detection electrodes are disposed, and a layer, on which the first and second common electrodes are disposed.

15. The touch screen panel of claim 1, further comprising:
a third detection electrode electrically connected to the electrode wire,
wherein the first common electrode and the second common electrode do not overlap the third detection electrode.

16. The touch screen panel of claim 15, wherein the first common electrode and the second common electrode extend along a first direction and are alternately disposed.

17. The touch screen panel of claim 16, wherein the first common electrodes have a plurality of first portions extending along a first direction and a second portion connecting the plurality of first portions, the second portion extending along one edge of the first substrate to be connected to a pad unit, and
the second common electrodes have a plurality of first portions extending along the first direction and a second portion connecting the plurality of first portions, the second portions extending along the other edge of the first substrate to be connected to the pad unit.

18. The touch screen panel of claim 17, wherein the first and second detection electrodes are disposed on one surface of the first substrate, and
the first and second common electrodes are disposed on the other surface opposite to the one surface of the first substrate.

19. The touch screen panel of claim 17, further comprising:
an insulation layer disposed between the first and second detection electrodes and the first and second common electrodes,
wherein the insulation layer, the first and second detection electrodes and the first and second common electrodes are disposed on one surface of the first substrate.

20. The touch screen panel of claim 17, further comprising:
a second substrate on which the first and second detection electrodes are disposed, and
an adhesive layer bonding the first substrate and the second substrate,
wherein the first and second common electrodes are disposed on the first substrate.
